(19) United States
(12) Patent Application Publication
(10) Pub. No.: US 2016/0173023 A1
(43) Pub. Date: Jun. 16, 2016

(54) Solar Power Panels, Arrays and Connection Systems

(71) Applicant: Sandia Solar Technologies LLC, Pagosa Springs, CO (US)

(72) Inventor: Henry L. Lomasney, Pagosa Springs, CO (US)

(21) Appl. No.: 14/883,276

(22) Filed: Oct. 14, 2015

Related U.S. Application Data
(63) Continuation of application No. 14/855,043, filed on Sep. 15, 2015, now abandoned.
Application No. 14/855,043 is a continuation of application No. PCT/US14/31108, filed on Mar. 18, 2014.
(60) Provisional application No. 61/801,772, filed on Mar. 15, 2013.

(51) Int. Cl. H02S 30/10

(52) U.S. Cl. CPC H02S 30/10

(57) ABSTRACT

Solar PV devices are disclosed, including but not limited to devices that comprise a lightweight support for the solar absorber, devices in which all or substantially all of the electronics for conducting and managing electrical energy are included in the device itself such that the device has little or no external wiring, devices that are dual insulated such that they reduce or eliminate the need for grounding circuits and the potential hazards associated with grounding faults, devices with structural members that reduce or eliminate the risk of electrical shock due to contact with metal parts during installation, and devices that provide heat dissipation. Methods of connecting and installing such devices and arrays of such devices are provided.

### CROSS-REFERENCE TO RELATED APPLICATIONS

This application claims the benefit of U.S. Provisional Patent Application No. 61/801,772, filed Mar. 15, 2013, which application is incorporated herein by reference in its entirety.

### FIELD

This disclosure relates to photovoltaic devices and systems, and methods for making them.

### BRIEF SUMMARY OF CERTAIN EMBODIMENTS DISCLOSED HEREIN

Embodiments described herein provide self-contained photovoltaic (PV) devices that can facilitate a simplified installation, with embodiments being capable of installation in a “plug and play” fashion. Embodiments of the devices and systems disclosed herein employ a “dual insulation” design, which means that the individual electrical components are themselves each insulated, and the components are then contained in an insulated enclosure that provides an additional electrically insulating barrier around the components. Embodiments of PV devices herein may meet the Class II electrical classification that is routinely related to electrical appliances.

In the case of a Class II or double insulated electrical appliance, the electrical system is designed in such a way that it does not require a safety connection to electrical earth ground. The basic requirement is that no single failure can result in dangerous voltage becoming exposed so that it might cause an electrical shock. This is achieved at least in part by having redundancy in the electrical insulation material surrounding live parts. Embodiments of this disclosure accomplish this by enclosing an insulated electrical components within an appropriately configured electrically insulating enclosure that is constructed of an electrically insulating medium, e.g., a Glass Fiber Reinforced Polymer (GFRP) structural medium. Double insulated embodiments described herein can pass one or more of the “Dielectric withstand test” or “Hipot test,” the “Protective bonding/continuity test” and/or the “Insulation Resistance Test” as specified in UL-1703. Embodiments described herein can pass two or more of such tests, or all three of such tests.

Embodiments of the devices and systems disclosed herein also include the positioning of various electrical components, e.g., components that provide an AC-PV system or DC-PV system within the devices, and embodiments enclose the components within the solar device, including embodiments that provide a hermetic (i.e., airtight), substantially airtight, waterproof or substantially waterproof seal for the electrical components and their electrical interconnection media. Parts of the enclosure may be electrically insulating and/or polymeric in nature.

Embodiments described herein provide relatively lightweight PV devices that are suitable residential and commercial installations. Such embodiments employ a semi-monocoque (SM) design as discussed herein. Although relatively lightweight, embodiments of the PV devices described herein pass the UL-1703 structural test criteria, which establishes the requirements for the devices to withstand the design loading and the corresponding bending or deflection limits.

Embodiments described herein also provide relatively lightweight PV devices that are designed to better withstand significant exterior temperature changes by providing a support for the PV absorber that has a coefficient of thermal expansion (CTE) that is less than that of tempered glass, i.e., less than 8.5×10⁻⁶ C⁻¹. Such embodiments reduce the stresses that can result from expansion and contraction of the components of the device with the change in temperatures during operation. Some embodiments of such PV devices employ a 3D-GFRP support for the solar absorber of the device, which 3D-GFRP comprises a glass-fiber loading and resin such that the CTE of the 3D-GFRP is below 8×10⁻⁶ C⁻¹, and may be as low as 7.5×10⁻⁶ C⁻¹.

Embodiments described herein provide relatively lightweight PV devices that are designed to permit dissipation of heat accumulated within the device. Some of such embodiments employ a 3D-GFRP that provide interior void spaces that permit convection of air through the voids, which convection permits the flow of warm air out of the 3D-GFRP and cooler air into the 3D-GFRP. Again, such PV devices meet UL-1703 testing requirements. Again, embodiments of such PV devices can pass the UL-1703 structural test criteria.

Embodiments disclosed herein can include polarized alignment elements within the connectors that reduce or substantially eliminates the possibility of an installation alignment error. Embodiments described herein also can include few or substantially no external metal parts associated with the module, thereby improving safety and reducing or eliminating the need for grounding circuits and the potential hazards associated with grounding faults. By eliminating the need for a grounding connection, embodiments described herein also can reduce or substantially eliminate the hazard of lightning strikes that can be associated with roof-mounted and ground-mounted solar arrays. Embodiments of the devices and systems disclosed herein also include the positioning of a PV system within an enclosure that provides a waterproof or substantially waterproof seal for the electrical components and their electrical interconnection media. In embodiments, the electrically insulating electrical enclosure may be an integral part of the support for the solar absorber. Embodiments described herein provide a system for inter-panel electrical connections that allow multiple panel arrays to be electrically interconnected using connectors. Embodiments herein provide the added advantage that the electronics that are installed on-site may now be installed and tested at the factory. Embodiments herein include the integration of functional testing of the fully installed and operational electrical system as an activity that is carried out as part of the panel production sequence. Hence, embodiments of devices herein have been subject to electrical performance testing and found to be working properly prior to installation.

Embodiments described herein also provide lightweight PV devices that possess sufficient structural integrity to withstand the normal operating conditions, e.g., wind and snow loads, that may be encountered with such systems. Embodiments described herein include self-contained, solar photovoltaic power devices that employ a semi-monocoque (SM) structure as described below. Embodiments of such SM structures can provide a stiff supporting structure for the solar absorber as well as an enclosure for electrical components that can conduct and manage electrical energy from the absorber. In embodiments, the enclosure comprises an electrically insulating material that provides an extra barrier of insulation for the electrical components. Embodiments of such devices can pass the UL-1703 structural test criteria. The decreased weight of such embodiments decrease the weight burden imposed upon the structure to which the PV device is attached.

Embodiments of the devices and arrays disclosed herein can be installed wherever solar devices may be installed, e.g., on a roof or in ground mount array. Embodiments of the devices disclosed herein may be mounted directly to a roof or surface without the need for brackets or a mounting system. Alternatively, where brackets and mounting systems are desired for installation, embodiments are provided herein that will facilitate such installation.

Embodiments disclosed herein thus can provide a PV device with one or more advantageous features, including but by no means limited to the following:
A SM structure that may be designed so as to provide a lightweight solar PV support structure having good specific strength and stiffness;
A ratio of weight of the PV device per power output (in grams per watt) that may be lower than 75 grams per watt;
A PV device that contains electrical components for conducting and managing electrical power from the absorber such that the device may be installed and tested at the factory prior to the delivery of the device to the field for installation;
A SM that incorporates GFRP structural members such as interior support members, perimeter members and upper and/or lower layers to provide electrical insulation, specific strength and production advantages;
A SM that comprises a 3D-GFRP as an upper layer to provide a stiff support for a solar absorber;
A SM in which the structural components are adhesively bonded;
A SM that comprises fire resistant, fire retardant or fireproof materials;
A SM that comprises glass fiber reinforced phenolic resin to provide structural properties;
A support for solar absorber having a Coefficient of Thermal Expansion (CTE) that is less than 8.5×10⁻⁶ C⁻¹ CTE, less than 8×10⁻⁶ C⁻¹, and may be as low as 7.5×10⁻⁶ C⁻¹;
A support for solar absorber having a CTE is in the range of from 7.5×10⁻⁶ C⁻¹ to 8×10⁻⁶ C⁻¹;
A 3D-GFRP comprising glass fiber at a weight of from about 40% to about 70% by weight, and a phenolic resin;
A PV device having a dual insulation design in which the electrical components of the device are contained in an electrically insulating enclosure in the SM;
A PV device constructed with structural members that reduce or eliminate the risk of electrical shock due to contact with metal parts during installation;
A PV device in which some or all of the electrical components are encased in an electrically insulating potting compound;
A dual insulated PV device that achieves a Class II-double insulated rating.
PV devices that include inter-panel connectors that reduce or eliminate the risk of electrical shock during construction of arrays of electrically connected panels;
PV devices comprising electrical connectors that provide reliable electrical connections;
PV devices comprising polarized alignment elements within the connectors that reduce or substantially eliminate the possibility of an installation alignment error;
PV devices comprising snap together connectors that provide improved electrical conduction properties; and
PV devices that facilitate simplified installation.

### DEFINITIONS

The following definitions are used in this disclosure:

“Array” means an installation comprising two or more solar PV devices.

“Dual insulated” as used herein means double insulated. For example, in embodiments described herein, dual insulation is achieved by enclosing insulated electrical components within an electrically insulating enclosure that provides an additional insulation barrier for the electrical components.

“Grounding circuit” means a ground bond circuit that positively maintains safe voltages on the chassis of an electrical device. A grounding circuit helps prevent an electric shock resulting from an insulation failure.

“Pultrusion” means a process for manufacturing composites with a constant cross-sectional shape. The process consists of pulling a fiber reinforcing material through a resin impregnation bath and into a shaping die where the resin is subsequently cured. The result of the pultrusion process is referred to herein as a GFRP (Glass Fiber Reinforced Polymer). A “pultrusion” can sometimes also refer to the GFRP made using a pultrusion process.

“3D-GFRP” means a three-dimensional GFRP that has more than a nominal thickness, and is made from glass woven fabric that has structure and weave of the fabric such that, when combined with a polymer that imparts structural strength and stiffness, the glass fiber rises to its predesigned height due to the polymer's surface tension related interaction between the resin and the glass. The rising of the glass fibers may also result in the formation of mm scale, longitudinal channels that run the length of the 3D-GFRP.

“Dielectric withstand test” or “Hipot test” means herein a test designed to stress the insulation of a solar panel far beyond what it will encounter during normal use. The testing procedure is specified in UL-1703 or IEC 61730-2.

“Protective bonding/continuity test” means herein a test that is designed to test the resistance of the grounding circuit on a solar panel. The testing procedure is specified in UL-1703.

“Insulation Resistance Test” means herein measuring the total resistance of a product's insulation by application of a 500V DC or 1000 V AC. The testing procedure is specified in UL-1703.

“Semi-monocoque” or “SM” as used herein refers to a load bearing support structure for the solar absorber that comprises a core and typically one or more exterior layers or “skin” elements, e.g., an upper layer on one side of the core that faces the solar absorber and a lower layer on the opposite side of the core, to deliver a desirable combination of weight, strength and stiffness.

“Inter-panel connector” or “IPC” as used herein means the electrical connecting member of a solar PV device that facilitates creating an electrical connection with an adjacent solar PV device. Embodiments of the IPC may incorporate low electrical resistance connecting elements designed for disconnection under load, with minimal arcing degradation. The IPC may be part of the SM itself or may be attached to the SM. In embodiments, the electrical interconnection becomes effective during field installation when electrical connection is effected between the IPCs of adjacent devices, e.g., by electrically connecting the devices. In dual insulated embodiments, the IPC will be designed consistent with the double insulated electrical features.

### BRIEF DESCRIPTION OF THE FIGURES

The appended figures, briefly summarized below, are provided for exemplary understanding of this disclosure and do not limit this disclosure in any way. The dimensions provided in the figures are merely for illustration purposes and other dimensions may be used as desired and as appropriate.

FIG. 1a is a top view of an embodiment of a dual insulated SM.

FIG. 1b is a top view of another embodiment of a dual insulated SM having IPCs.

FIG. 1c is a top view of an embodiment of a dual insulated SM illustrates having IPCs and a lower layer tendon.

FIG. 2 illustrates an embodiment of a connection between an interior support member and a perimeter member of a SM.

FIG. 3 illustrates the cross section of a 3D-GFRP.

FIGS. 4a and 4b illustrate one embodiment of an IPC configuration for end-to-end attachment, and attachment with a top connector.

FIG. 4c illustrates one embodiment of an IPC configuration with side-by-side attachment and attachment with a top connector.

FIGS. 5a and 5b illustrate one embodiment of an IPC configuration for end-to-end attachment with additional external tubular members on the SMs for attachment to an external roof-mounting assembly.

### DETAILED DISCUSSION

### The GFRP and 3D-GFRP

Embodiments of the devices of this disclosure can be prepare using any number of materials, including but not limited to metals, non-metals such as glasses, carbon fibers or other non-metallic materials, plastics, foams, polymers and polymer composites. In a number of embodiments disclosed herein, the device may comprise GFRP and 3D-GFRP polymer composites. Such composites can provide a number of advantages because they can be relatively lightweight, stiff, electrically insulating, corrosion-resistant and in some embodiments, fire-resistant.

As noted above, the GFRPs comprise glass fibers and polymer resin and can be prepared by the process of pultrusion. The glass fiber filled composite can utilize a number of binder polymers, including but not limited to, e.g., phenolic, epoxy, vinyl ester and polyester resins. Determining acceptable binder polymers for any particular PV device will take into account considerations such as, e.g., cost, CTE, processing characteristics, fire resistance, and rheological properties of the binder polymer.

3D-GFRPs are prepared from specially woven glass materials that expand to a predetermined thickness upon viscous liquid contact with the resin binder, and which upon cure of the said resin (or polymer binder), can form a flat, rigid member having a high level of specific stiffness and that may include interior channels. One example of a suitable 3D-GFRP composite material is Parabeam which is produced by the company PARABEAM located at 5700 AC Helmond; the Netherlands. www.parabeam3d.com. Advantageously, a polymer binder is then applied to the Parabeam in order to achieve the required structural composite properties. Acceptable polymer binders include, for example, phenolic, vinyl ester, epoxy, and polyester. The phenolic resin is one good candidate due to its properties of low cost, high crosslink density, low CTE, high operating temperature and fire resistance.

One possible method for preparing the 3D-GFRP is to meter the resin such that the ratio of glass fiber to resin is kept reasonably uniform and controlled throughout the composite. This process can be performed on a substrate that will permit removal of the panel when the processing is completed. The production process can involve an appropriate curing cycle, and also can involve rolls of glass fiber blanket that facilitates a continuous production process.

As noted, the polymer advantageously can impart fire resistant or retardant properties, e.g., a phenolic thermosetting resin. Other resins that may be used include, e.g., epoxy, vinyl-ester and polyester. Criteria for selecting the resin for the 3D-GFRP include the production and processing protocol that is preferred, cost considerations, desired fire resistance and/or retardant properties, and structural properties such as CTE of the resulting 3D-GFRP. The glass fiber-to-polymer ratio can be controlled by employing appropriate process controls during the polymer impregnation process. As discussed below, the amount of glass loading and chosen resin may be tailored to achieve a desired property such as a CTE that is closer to the CTE of the solar absorber than the CTE of tempered glass. Glass loadings (either “E” glass and/or “S” glass) above 30% thus may be desired, e.g., above 35%, above 40%, above 45%, above 50%, above 55%, above 60%, above 65%, and above 70%. Once formed, the 3D-GFRP can provide desired strength and stiffness properties to the SM and the device.

### The Semi-Monocoque (SM)

As discussed above, a SM can be used as a load bearing support structure for the solar absorber. The SM typically comprises a core and one or more exterior layers or “skin” elements, e.g., an upper layer on one side of the core that faces the solar absorber and a lower layer on the opposite side of the core, that when combined can provide a support structure that has a good combination of weight, strength and stiffness. When experiencing downward loading from the solar absorber, the upper layer of the SM is in compression and the lower layer is in tension. The core resists the shear loads and increases the stiffness by holding the upper and lower stress-carrying layers apart. In embodiments herein, the SM provides a support for a solar absorber that is bonded directly to an upper layer on the SM or indirectly through one or more layers interposed between the absorber and the SM upper layer of the SM.

The SM Core

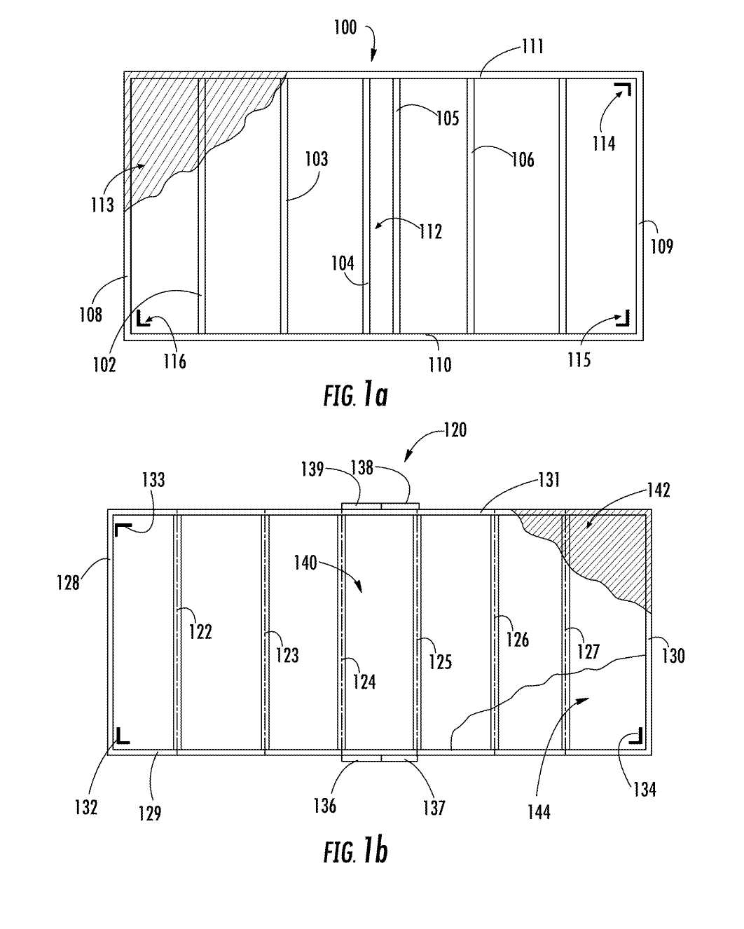

The SM core typically will consist of one or more internal support members and one or more perimeter members that define a continuous or discontinuous rectangular outer boundary of the SM. Because solar panels are typically rectangular, the perimeter members typically will define a continuous or discontinuous rectangular outer boundary of the SM. The internal support members, which, when they extend from one side to the other as shown in FIGS. 1a-1c, may be referred to as “ribs.” When the perimeter members define four sides of the rectangle as shown in FIGS. 1a-1c, they may also be referred to as “rails”. Shapes other than rectangular are of course possible. Moreover, although the SM may be constructed to have separate internal support members and perimeter members, it is possible to provide internal support members that are shaped (e.g., “L” shaped, “T” shaped or tubular) such that they provide both the internal support and also define in part or whole the perimeter of the core, thereby reducing or eliminating the need for separate perimeter members. Indeed, the core could even be fabricated as a single, integral member that both provides the core's internal support and defines the SM's perimeter.

Although illustrated in FIGS. 1a-1c as straight members extending from one side of the core to the opposite side, the internal support members can be of any design, e.g., a chessboard-like design of crossing members, a honeycomb-like design, or any other design that accomplishes the goal of providing adequate support and stiffness for the device. The internal support members and perimeter members can be of various shapes, e.g., “C” shaped, “I” shaped, or tubes of rectangular cross section.

Generally speaking, the core materials should help provide the desired strength and stiffness for the SM. Any number of materials may be used in the core, including but not limited to metals, non-metals such as glasses, carbon fibers or other non-metallic materials, plastics, foams, polymers and polymer composites. The GFRPs described herein can serve as the internal support members and/or the perimeter members, and can provide a number of appropriate properties because they can be readily shaped through pultrusion and are relatively lightweight, stiff, electrically insulating, corrosion-resistant and in some embodiments, fire-resistant.

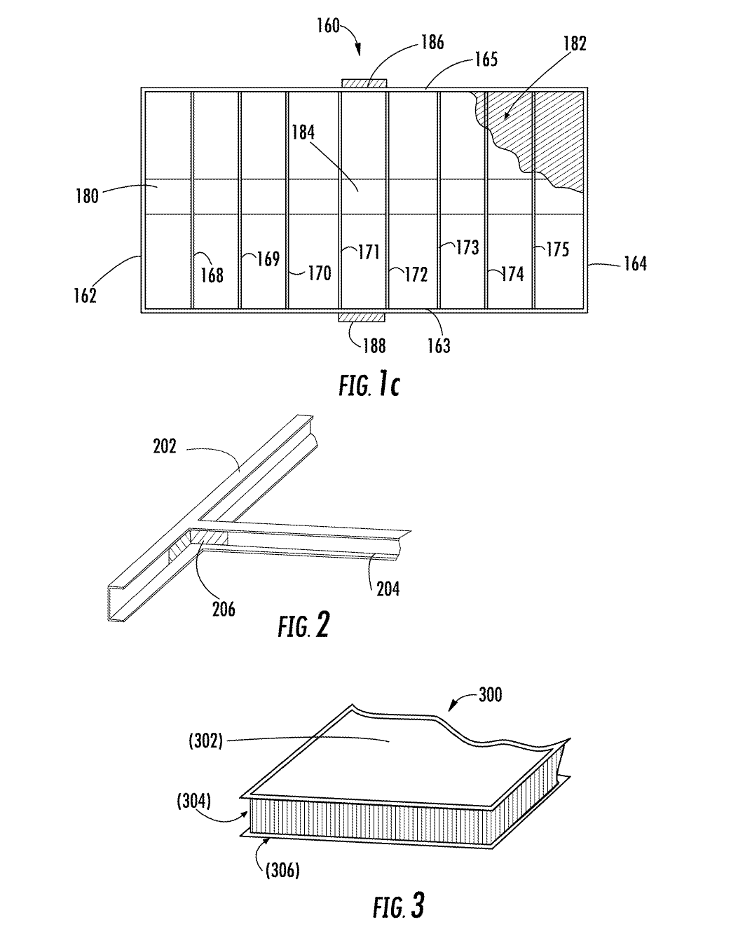

In embodiments where the core comprises a rib and rail structure, the attachment of the ribs to the rails can be performed in any number of ways, including by mechanical attachment and/or by adhesive attachment. First the railings and the ribs are secured by fasteners or adhesive in a manner that maintains the alignment and relative positioning. When this is achieved, a structural clip of proper size and shape may be positioned at the interface between the rib and the railing (see, e.g., FIG. 2), and may be adhesively bonded. Designs other than ribs and rails may be fastened using any appropriate processing technique including mechanical fasteners, reinforced polymer layups, and/or adhesive.

Thereafter, in embodiments that employ upper and/or lower layers, the layer(s) may be mechanically fastened and/or adhesively bonded to the internal support members and perimeter members at the contacting surfaces, which are typically presented by the top surface of those members. In embodiments where GFRPs are used as core internal support and perimeter members and the lower layer, and a 3D-GFRP is used as the upper layer, a two part-aliphatic epoxy polymer cured with a polyamidoamine curing agent provides acceptable results. Such a material can be modified with a fumed silica to impart desired rheology, i.e., desirable thixotropic properties, and catalytic additives can be added to accelerate the cure. The adhesive can be packaged into premeasured cylinders that permit the two components to be simultaneously forced through a mixing tube, by means of an appropriately configured adhesive gun. Alternatively, where the production design permits rapid curing, polyurea adhesives that can be cured in short times such as seconds to minutes can be employed. It also is possible to use prepreg tapes or structural tapes manufactured by firms such as 3M.

The Top and Bottom Layers

The underside of the semi-monocoque, i.e., the side not supporting the absorber, comprises a bottom layer that may partially or completely cover the bottom side of the monocoque. The lower layer needs only to be able to carry the amount of stress necessary for delivering the desired strength to the SM. For example, as discussed below in connection with FIG. 1c, in one embodiment the lower layer may simply be a tendon-like member that has a width much less than the width of the SM core and extending from one region of the underside of the SM to another region. Further, the bottom layer may be continuous or discontinuous, i.e., it may be made up of a single piece of material adhered to the underside or multiple pieces of material that are adhered to the underside, and the bottom layer may have openings or gaps in the single piece or multiple pieces. The lower layer thus can be comprises of multiple discrete, abutting and/or overlapping pieces. Alternatively, the stressed element of the backing region may even be a part of the core's structural members, namely those regions that are placed in tension when the downward loading is imposed, with no additional covering over the structural members. For example, the lower layer may simply be the flanges or bottom portions of the internal support members, such as those that are “C” shaped, “I” shaped, or tubes of rectangular cross section.

The uppermost layer of the SM provides support to the solar PV layers which are superimposed thereon. These PV layers may include the solar absorber cells, the encapsulation media which bonds the absorber cells to the SM's upper layer and an exterior film which provides the physical barrier and weather protection for the system. For example, such a PV layer configuration can include silicon solar cells, ethylene vinyl acetate, and fluoropolymer films such as ETFE and FEP.

In some embodiments, this upper layer is continuous and is made up of a single piece of structural skin material that is adhesive bonded to the core media. As with the bottom layer, the upper layer may partially or completely cover the top side of the monocoque, i.e., the side supporting the solar absorber. The upper layer needs only to be able to carry the load of the device that is supported by the SM, and provide sufficient stiffness to resist bending or deformation so as to maintain its integrity under the specified maximum load conditions that may be encountered in operation. For example, in one embodiment the upper layer also may simply be a tendon-like member that has a width less than the width of the SM core but approximately the width of the absorber and extending from one region of the topside of the SM to another region.

Further, the upper layer may be continuous or discontinuous, i.e., it may be made up of a single piece of material adhered to the topside or multiple pieces of material that are adhered to the topside, and the upper layer may have openings or gaps in the single piece or multiple pieces. The upper layer thus can be comprises of multiple discrete, abutting and/or overlapping pieces. Alternatively, as with the lower layer, the upper layer may even be a part of the core's structural members, namely those regions that are placed in compression when the downward loading is imposed, with no additional covering over the structural members. For example, the upper layer may simply be the flanges or top portions of the internal support members, such as those that are “C” shaped, “I” shaped, or tubes of rectangular cross section.

The upper and lower layers can comprise any material that meets the physical requirements of the SM and the PV device, e.g., metals, non-metals such as glasses, carbon fibers or other non-metallic materials, plastics, foams, polymers and polymer composites. The upper layer may comprise a laminate of materials that provide the requisite strength and stiffness. In one embodiment, for example, the upper layer may comprise a GFRP. In another embodiment, the upper layer may comprise a 3D-GFRP. In other embodiments, the upper layer may comprise a 3D-GFRP and one or more layers interposed between the 3D-GFRP and the core. As another embodiment, the SM may comprise an upper layer that is relatively thin by with a 3D-GFRP or other stiff supporting member above the upper layer. Alternatively, the internal supporting members of the core may themselves be sufficiently close together to yield the required support to the solar cell to mitigate any cracking during the anticipated lifetime and the anticipated design load parameters including wind and snow loads. In yet other embodiments, the upper layer may incorporate foams as a core structure including skins that use thin phenolic skins and phenolic foam cores. In yet other embodiments, the core and upper and lower layers can be integrally formed to be essentially a single piece.

In some embodiments, the SM is fabricated to have a coefficient of thermal expansion (CTE) that is as near the CTE of the absorber as is reasonably practical. This CTE value relates to the dimensional variance of a material as it is exposed to a temperature change. If materials having differing CTE values are in intimate contact, the result may be a significant amount of strain when temperature changes. In some embodiments, therefore, it is desirable to minimize the difference in the CTEs of the SM and the elements of the solar PV layer. Some silicon solar wafers have a CTE value of about 2.8×10⁻⁶ C⁻¹. The corresponding CTE value for “E” glass is reportedly 5.4 and the value for “S” glass is 2.9. Composite materials comprised of a combination of glass fiber and binder polymer can provide a CTE value that is closer to that of the silicon solar wafer than tempered plate glass. “E” glass fiber and even more advantageously the “S” glass fibers can provide the means to such a GFRP composite. Such composites comprised of combination of glass fiber and a binder polymer can provide a CTE value that is more proximate to that of the silicon solar wafer. For example it has been shown that the glass fiber reinforced composite skins and structural shapes when combined with appropriate resin media such as a phenolic resin and which have a glass loading (“E” glass fiber) above 50% by weight of the total composite weight can exhibit a CTE value in the range of 8×10⁻⁶ C⁻¹ and as the glass loading (“E” glass fiber) reaches the range of 60 percent, the CTE can become approximately 7.5×10⁻⁶ C⁻¹. Use of substantial amounts of “S” glass fibers may reduce the CTE below 7.5×10⁻⁶ C⁻¹. Accordingly, embodiments of 3D-GFRPs having a glass fiber loading (either “E” glass and/or “S” glass) that is greater than 50% are expressly contemplated herein. For example, glass loadings (either “E” glass and/or “S” glass) above 55%, above 60%, above 65% and above 70% may be desired.

Where upper and/or lower layers of materials are used, they should be fastened to the core, e.g., by a form of structural attachment such as a suitable adhesive bonding media or mechanical fasteners. Suitable adhesives include rapid set epoxy adhesives, polyurea adhesives whose cure takes place in short times such as seconds to minutes, prepreg tapes and structural tapes, such as those manufactured by 3M Corporation, and thermoplastic adhesives. These can be applied using automated and robotic equipment. Electron beam, induction heating and uv curing can be used to deliver rapid curing.

### Inter-Panel Connectors (IPCs)

When constructing arrays of individual solar PV devices or “panels,” it is necessary to electrically connect the individual panels. Embodiments described herein comprise connectors that are integral to the panels and which facilitate electrical connection of individual panels, i.e., inter-panel connectors (IPCs).

The IPCs permit two adjacent panels to be brought into electrical contact. In some embodiments, the IPCs may comprise a connector on each panel that is designed to physically mate with another to create an electrical connection. In other embodiments, the arrangement of these IPCs may comprise a pair, which are brought into proximity as part of the field installation. This pair may be subsequently joined by a third connector that functions as a jumper to electrically connect the IPC pair. In such cases, the third connector can be integral to the pre-installed panel or a separate, unattached connector that is added after the panels are placed adjacent to one another. In some embodiments, the IPCs are designed to abut or fit together such that if a panel requires service or malfunctions, then this panel can be disconnected from its adjacent panel(s) and removed without the need to disturb or detach adjacent panels. That is, the IPCs are in proximity to one another but do not physically overlap or otherwise significantly interfere with one another such that a single panel can be removed and replaced fairly easily.

Embodiments of the IPC may incorporate low electrical resistance connecting elements designed for disconnection under load, with minimal arcing degradation. In some embodiments, the IPCs may comprise electrical leads and contacts that are incorporated in the inter-panel connector design, and can optionally utilize contacts that are metallic or metal-plated (e.g., silver on copper) and body and stainless steel spring features that permit snap-fit connections. In such case, the stainless steel spring and wiping contact connector option can provide a secure-and reliable connection during the electrically loaded connecting or hot-plug disconnecting activities that can occur with solar panel installation and operation.

Where a SM is employed, the IPC may be part of the SM or may be attached to the SM or other part of the PV device. When used in conjunction with the dual insulated embodiments described herein, the IPC can be designed consistent with the double insulated electrical features. For example, the IPC can substantially comprise electrically insulating material such as a GFRP material into which are placed contacts that are not exposed externally, thereby decreasing the chance that an installer will come into contact with an electrically conducting metallic part.

Exemplary embodiments of IPCs are described below in connection with the figures.

### Electronics

Embodiments of PV devices described herein are designed to operate as an array comprising multiple PV devices or panels that are connected by combinations of series or parallel circuits. As mentioned above, embodiments of the devices herein may be manufactured to include within the device some or all of the electrical components for conducting and managing the electrical energy coming from the solar absorber. The electrical components that are candidates for theses embodiments include but are not limited to wires, diodes, overcurrent protectors such as fuses, circuit breakers and surge protectors, busbars, micro-inverters, MPPT circuitry and circuitry for detecting whether the PV device is operating properly and/or malfunctioning. The PV devices also may include components and circuitry, including e.g., telecommunications or wifi technology, to transmit information concerning the operation of the PV device and/or malfunctions to a remote location where the information can be monitored.

Embodiments of such arrays can conduct electrical energy throughout the array as DC power, which DC power ultimately may be converted to AC by an inverter at a location near or remote from the array, and eventually to a local application (load) or alternatively to a power grid. Alternatively, embodiments of the PV devices herein may include micro-inverters as part of the electronics of the individual PV device, each panel thus providing AC electrical output.

In embodiments where a SM is employed, the electrical components may be positioned within an enclosed area in the SM, with wiring to an IPC or other connector external to the PV device for communicating electrical power from the PV device. In such embodiments, it may be advantageous to provide a hermetic (i.e., airtight), substantially airtight, waterproof or substantially waterproof seal for the electrical components and their electrical wiring. If the enclosure is constructed from electrically insulating materials such as GFRPs and 3D-GFRPs, then the enclosure can provide an additional electrical barrier, thus rendering the components in the enclosure doubly insulated. Parts of the enclosure may be electrically insulating and/or polymeric in nature. The electrical components also may be embedded in a potting compound. In such case, they may be within the enclosure or no enclosure may be employed.

For embodiments of solar PV devices in which electrical components have been included in the device itself, the PV device may be pre-tested following manufacture to determine whether the components and PV device are performing properly. Such performance testing prior to installation permits more efficient testing under factory conditions and reduces the shipment of malfunctioning PV devices, thereby improving quality and reliability assurance of the device. In this case such testing methodology can be found in UL-1703. Examples of these tests include the Dielectric withstand test or Hi-Pot test, continuity testing as well as the insulation resistance testing. Embodiments of this disclosure can pass one, two or all three of these tests.

### The Solar Absorber and Associated Materials

The solar absorber may consist of any of the materials that are capable of converting sunlight into electricity. Examples are monocrystalline or amorphous silicon, CIGS, gallium arsenide, and cadmium telluride.

In some embodiments, the solar absorber may be covered with a tempered glass plate. In other embodiments, the absorber is covered with a suitable polymeric covering. Examples of polymers that can be employed for such purpose include fluorinated polymers such as ethylene tetrafluoroethylene copolymer (ETFE), fluorinated ethylene propylene (FEP), and polyvinylidene fluoride (PVDF). Such polymers provide extended lifetimes under ambient exposure conditions. These also exhibit light transmission property that exceeds the light transmission efficiency of glass by a few percent. These fluoropolymer films are characterized by their low surface energy, which may contribute to maintaining a cleaner surface. An alternative polymeric film for the exterior layer of the solar absorber is composed of a polycarbonate polymer (such as the polymer that is marketed under the commercial name of LEXAN).

Various processes may be used to provide a polymeric covering over the absorber including: applying the coating wet over the absorber followed by curing; adhering a preformed polymeric film layer over the absorber using an adhesive film: alternatively by heating a thermoplastic film such as acrylic that is placed over the absorber to cause it to adhere to the absorber in a manner that results in an airtight and watertight encapsulation.

In embodiments where the absorber is covered by a fluoropolymer film and supported by a 3D-GFRP, one process for securing the fluoropolymer film onto the glass fiber reinforced composite panel is accomplished using vacuum lamination. Laminator equipment for vacuum lamination may be divided by a flexible membrane into vacuum chambers, one chamber resting on a plate receives the stacked layers that will comprise the solar-cell system that includes the silicon wafers, the fluoropolymer film and the bonding and encapsulation films. The polymer film material which is preferably used for bonding and encapsulation is ethylene vinyl acetate (EVA). Initially, the plate temperature is kept below the softening point of this EVA. Next the two chambers are evacuated and the plate temperature is raised to the softening point of the encapsulating materials. Subsequently the upper chamber is ventilated and as a result, the flexible membrane is forced against the stack. In this way, a composite is formed comprising the solar cells and encapsulating materials. The encapsulating materials are hardened by further raising the temperature and thereafter the plate is cooled and the laminate is removed from the vacuum chamber.

In embodiments where a SM is employed, the multilayered absorber media and its associated 3D-GFRP, including the encapsulating materials, may then be affixed (or adhered) to the topside of the core internal supports and perimeter members (if not already covered by a structural skin layer). This can be fastened mechanically or by application of an adhesive to some or all of the contacting surfaces of the core and 3D-GFRP. Alternatively, if the core has been previously covered with a structural skin layer, the 3D-GFRP may be adhered to the said covering layer by suitable adhesive or mechanical fasteners.

### Installing the PV Devices

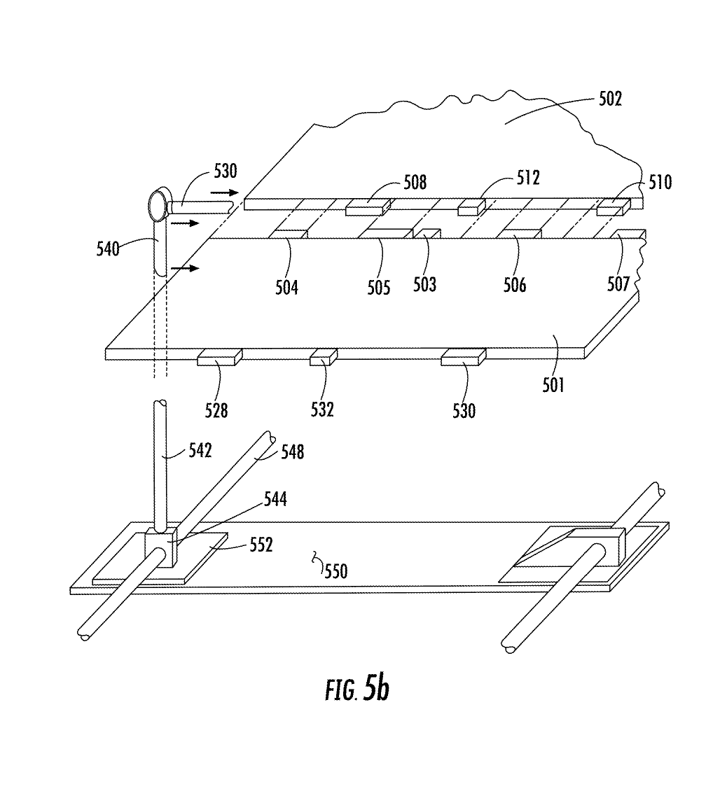

Embodiments of the PV devices may be installed in a number of ways. For example, in embodiments comprising a SM support for the absorber, the PV device may be adhered directly to a rooftop or other structure by adhering the underside of the lower layer directly to the roof or other surface using an adhesive, or by mechanically fastening part of the device to the roof surface. Alternatively, they can be installed on a rooftop or a ground-mounted configuration using any suitable external mounting system, one example of which is illustrated in FIG. 5b.

### Detailed Discussion of the Figures

Referring now to the figures, FIGS. 1 and 2 provide examples of various embodiments of SMs that include various of the above-described features and elements.

FIG. 1a illustrates an embodiment of an SM for use in a solar panel. This embodiment illustrates a dual insulated design as disclosed herein. The core of the SM comprises interior support members or ribs 102-107 and perimeter members or railings 108-111. The interior support and perimeter members may be made from, e.g., GFRP composites. Although shown as separate components in this embodiment, the support members and perimeter members also could be formed as one integral structure or from multiple structures joined together. Enclosure 112 illustrates the electrical enclosure which houses the wiring and electronics (not shown) to provide the dual insulation feature of this embodiment. In this embodiment, upper layer 113, to which the solar absorber is directly or indirectly attached, comprises a 3D-GFRP as described herein. Attaching members (clips) 114, 115 and 116 illustrate one embodiment of connectors to attach the perimeter members (see also FIG. 2). The clip under upper layer 113 is not shown. The interior support members can be attached to perimeter members via connectors such as clips (not shown) or simply adhered to each other via adhesive, or individually adhered to the top and bottom layers, which will then hold the interior support members and perimeter members in place.

Consistent with the disclosure herein, the SM 100 also will comprise a lower layer, not shown. As disclosed herein, the SM 100 also may include an inter-panel electrical connector, structural interlocking feature(s), and one or more integral members for mounting the device to a surface (all not shown).

Note also that alternatively, any of the SMs described in this disclosure could be designed with the interior support members running the length of the SM instead of the width as shown. Alternatively, as discussed above, the interior support members could be in a honeycomb design or other design that satisfies the goals of providing a SM of sufficient structural integrity for the application, and advantageously one that passes the mechanical loading test criteria of UL-1703. Embodiments in which the interior support members are running the length of the SM are thus merely shown for illustration purposes and not as a limiting feature.

Exemplary dimensions for the SM as shown, e.g., are as follows: 77.5 in. length and 39.5 in. width outside dimensions; 12.25 in. from the outside of perimeter members 108 and 109 to the center of support members 102 and 107, respectively; 12.25 in. from the center of support members 102 and 107 to the center of support members 103 and 106, respectively; 12.25 in. from the center of support members 103 and 106 to the center of support members 104 and 105, respectively; and 8 in. from the outside of the support member 104 to the outside of support member 105, which support members define the enclosure 112. Each of the GFRP perimeter and support member may be configured, e.g., as “C” shaped members (see, e.g., FIGS. 2), and 2 5/16×¾×⅛ (height, width and thickness).

Referring now to FIG. 1b, another example of a semi-monocoque as described herein 120 is provided. This illustrates an embodiment of a SM that is smaller than the exemplary dimensions provided for FIG. 1a. The embodiment of FIG. 1B thus may be made thinner and lighter than an SM having the dimensions exemplified in FIG. 1A. In this embodiment, the core's interior support members 122-127 and perimeter members 128-131 are comprised of hollow one inch square×⅛ inch tubular pultrusion GFRP. For reasons discussed below, connector clips 132, 133 and 134 are optional in this embodiment.

Inter-panel connectors 136, 137, 138 and 139 are provided. Interior support members 124 and 125 define the sides of enclosure 140, which houses the electronics (not shown) of the device. Upper layer 142 and lower layer 144 are partially shown. In this embodiment, lower layer 144 substantially covers the underside of the SM, thereby providing a surface by which the solar device may be directly adhered to a surface such as a roof. The enclosure 140 located between the interior support members 124 and 125 may provide an electrically insulating enclosure for electrical components for conducting and managing electrical energy from the absorber, e.g., electrical wires, connectors, diodes, MPPT circuitry, and smart electronic features (not shown). There is no externally exposed wiring in this embodiment.

Exemplary dimensions for SM 120 are as follows: 47.6 in. length and 21 in. width outside dimensions; the perimeter members 128 and 130 and interior support members 122-127 are spaced substantially equidistant apart, each 6.8 in. apart measured from center to center.

In this embodiment, both the upper layer, e.g., a 3D-GFRP and the lower layer, e.g., a GFRP, are adhesively bonded to the interior support members and perimeter members, which makes the use of connector clips or other attachment members optional. A polyamidoamine cured epoxy adhesive can provide the desired bond strength to bond the upper and lower layers to the interior support and perimeter members. Approximately five percent by weight of silica aerogel may be added to the polyamidoamine epoxy adhesive to provide desired rheological properties.

Referring now to FIG. 1c, another embodiment of a semi-monocoque 160 is exemplified. The core comprises perimeter members 162-165 and interior support members 168-175. In this embodiment, the lower layer comprises a strip or tendon 180 that runs the length of the SM. The strip 180 may be of any material that provides strength and stiffness to the SM. Strip 180 also may be electrically insulating, e.g., a GFRP. The upper layer 182 also may be of any material that provides strength and stiffness to the SM, and which advantageously is electrically insulating, e.g., a GFRP or 3D-GFRP. The electronics (not shown) are enclosed in the enclosure 184 created by the interior support members 171 and 172, and the lower layer 180 and upper layer 184. When the interior support members and upper and lower layers are electrically insulating, then the enclosure 184 will provide a second layer of insulation to the electrical components, thereby providing a dual insulation feature. Inter-panel connectors 186 and 188 provide the device with the ability to connect to adjacent panels.

FIG. 2 illustrates one embodiment of interior and perimeter support members and a connector for joining them. Perimeter member 202 and interior support member 204 are shown as “C” shaped members. They are held together by an attachment clip 206 that is adhesively bonded on both faces to the members 202 and 204.

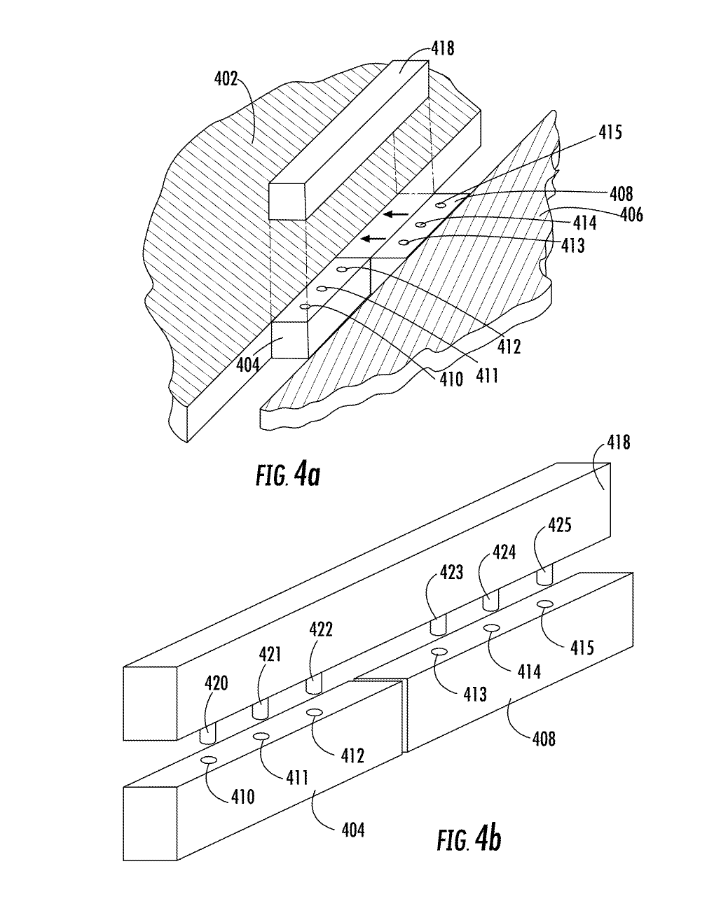

FIG. 3 illustrates an embodiment of a 3D-GFRP 300 that may comprise the upper layer and/or lower layer of the SM. The 3D-GFRP 300 comprises a top member 302 and a bottom member 306, and internal glass fibers 304. In this embodiment, the 3D-GFRP comprises a glass woven fabric from Parabeam Corporation, which is then combined with a polymer to create the 3D-GFRP. Advantageously, the polymer imparts structural strength and stiffness to the 3D-GFRP. The fabric imbibes the resin and due to the capillary forces of the glass fabric causes the glass fiber to rise to its predesigned height, thus forming the core of the 3D-GFRP. The rising of the glass fibers also will result in the formation of micro-(or mini) longitudinal channels that run the length of the 3D-GFRP, such channels potentially proving for convective airflow through the 3D-GFRP by a “chimney effect” that can contribute to heat dissipation to cool the internal portion of the 3D-GFRP.

Also advantageously, the polymer can impart fire resistant or retardant properties, e.g., a phenolic thermosetting resin. Other resins that may be used include, e.g., epoxy, vinyl-ester and polyester. Criteria for selecting the rein include the production and processing protocol that is preferred, cost considerations, desired fire resistance and/or retardant properties, and structural properties such as CTE of the resulting 3D-GFRP. The glass fiber-to-polymer ratio can be controlled by employing appropriate process controls during the polymer impregnation process. Once formed, the 3D-GFRP can provide desired strength and stiffness properties to the SM and the device.

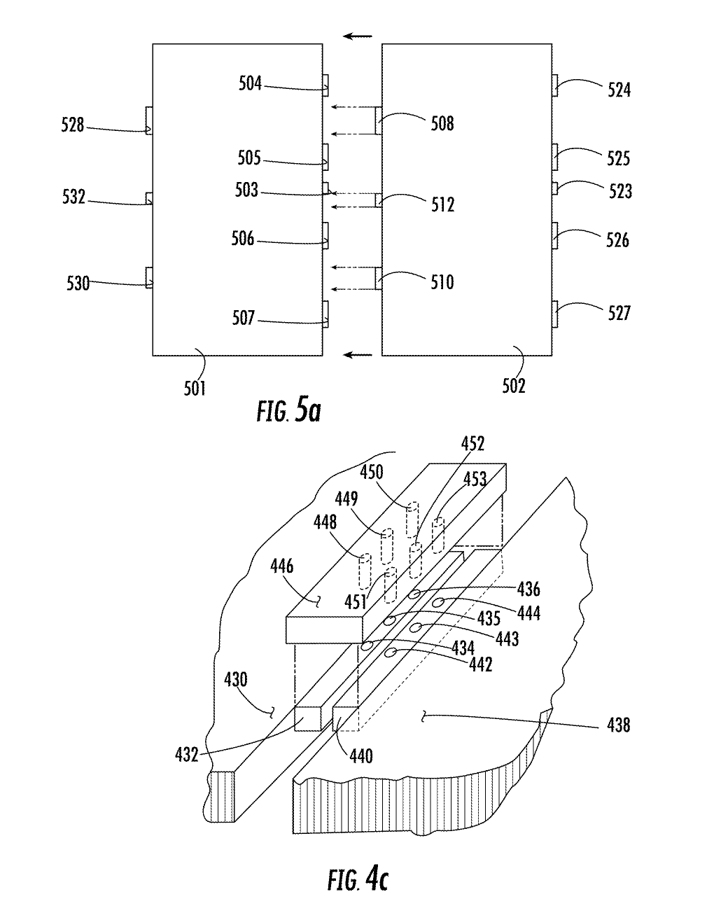

FIG. 4a illustrates one embodiment of inter-panel connectors that may be used to electrically connect two adjacent solar PV devices. In this embodiment, once properly aligned, the IPCs are in an end-to-end orientation. SM 402 comprises IPC 404. SM 406 comprises IPC 408. IPCs 404 and 408 may be constructed of any electrically insulating material such as a GFRP. IPC 404 contains embedded electrical contacts 410-412. IPC 408 contains embedded electrical contacts 413-415. As illustrated in the Figure, the two SMs are moved into intimate contact such that the electrical contacts 410-415 are aligned. When these are properly aligned, the top connector 418, which contains mating electrical contacts (shown in FIG. 4b) is pushed into place to achieve electrical connections between the contacts in the top connector 418 and the electrical contacts in the IPCs 404 and 408.

FIG. 4b illustrates the installed arrangement of the IPCs 404 and 408 with the top connector 418 shown in FIG. 4a. As shown in this figure, the top connector 418 comprises mating electrical contacts 420-425 that mate with and connect to electrical contacts 410-415 in IPCs 404 and 408. When mated, the electrical power from the two PV devices will be in electrical communication.

FIG. 4c illustrates an alternative arrangement of IPCs. In this embodiment, once properly aligned, the IPCs are oriented in a side-by-side configuration. SM 430 comprises IPC 432 with electrical contacts 434-436. SM 438 comprises IPC 440 and electrical contacts 442-444. Top connector 446 comprises contacts 448-450 and 451-453. When the IPCs 432 and 440 are abutted, and the electrical contacts aligned, top connector 446 is pushed into place to achieve electrical connections between the contacts 448-450 and 451-453 in the top connector 446 and the electrical contacts 434-436 and 442-444 in the IPCs 404 and 408, respectively.

FIG. 5a illustrates embodiment of PV devices that are configured for roof mounting using an external racking system. SM 501 comprises IPC 503 and aligned external tubular members 504-507, which are adhesively bonded or otherwise fastened to the perimeter member or railings of SM 501 (shown in FIG. 5b). SM 501 also comprises on the opposite side aligned external tubular members 528 and 530, and IPC 532. SM 502 comprises IPC 512 and aligned external tubular members 508 and 510, which are adhesively bonded or otherwise fastened to the perimeter member or railings of SM 502 (not shown). SM 502 also comprises on the opposite side aligned external tubular members 524-527 and IPC 523. In mounting the PV devices, the IPCs 503 and 512 are brought into end-to-end alignment (as described above in FIGS. 4a and 4b), which then brings the external tubular members 504-507 of SM 501 into alignment with external tubular members 508-510 of IPC 502. Thereafter, a top connector (not shown) may be pushed into place as described above, and the assembly is then mounted to the external racking system as described below in connection with FIG. 5b. The asymmetrical positioning of both the tubular members and IPCs on opposite sides of each of the panels helps prevent improper connection and alignment between adjacent panels. That is, if an installer attempts to install adjacent panels incorrectly, the IPCs and external tubular members will not align properly.

FIG. 5b illustrates mounting of the SMs 501 and 502 using an external racking system. As shown, SMs 501 and 502 have been brought into alignment such that IPCs 503 and 512 are brought into end-to-end alignment, and external tubular members 504-507 of SM 501 are brought into an aligned row with external tubular members 508-510 of IPC 502 such that a corridor results on each side of the IPCs. As illustrated, an appropriately sized tube 530, e.g., a pultruded GFRP, can be pushed into the corridor created by aligned external tubular members 507, 510 and 506. The corresponding tube on the other side of the assembly is shown already pushed into the corridor created by aligned external tubular members 504, 508, 505 and 509. As also illustrated, the tube element 530 is also configured to connect to a field adjustable standoff leg 540. The opposite leg is shown. Standoff leg 542 extends to leg attachment bracket 544, which may be bonded to the base 550. Leg attachment bracket 544 engages a longitudinal tubular support rail 548. Standoff leg 540 has a corresponding assembly (not shown). This tubular support rail 548 also engages base attachment bracket (552) which is in turn affixed to the base 550. The base is then affixed to the roof by means of an adhesive medium or other appropriate attachment mechanism. All of the members of the external mounting system may be constructed of any material. One acceptable material is a pultruded GFRP, which is non-conductive, non-corrosive, and provides high specific strength.

### Embodiments

The following is a list of some of the embodiments disclosed herein:

| | |
|---|---|
| 1. | A device for collecting solar photovoltaic power comprising a support, a solar absorber |
| | that is directly or indirectly mounted on the support, and electrical components for conducting |
| | and managing electrical energy from the absorber, wherein the electrical components are |
| | contained within an enclosure in the device, and wherein the enclosure is electrically insulating. |
| 2. | A device for collecting solar photovoltaic power comprising a support and a solar absorber |
| | that is directly or indirectly mounted on the support, wherein the support comprises a |
| | semi-monocoque. |
| 3. | A device for collecting solar photovoltaic power comprising a support and a solar absorber |
| | that is directly or indirectly mounted on the support, wherein the support comprises a 3D-GFRP. |
| 4. | A device for collecting solar photovoltaic power comprising a support and a solar absorber |
| | that is directly or indirectly mounted on the support, wherein the support comprises |
| | a 3D-GFRP, and wherein the CTE of the 3D-GFRP is less than 8 × 10⁻⁶ C⁻¹. |
| 5. | A device for collecting solar photovoltaic power comprising a semi-monocoque support, |
| | a solar absorber that is directly or indirectly mounted on the support, and electrical components |
| | for conducting and managing electrical energy from the absorber, wherein the electrical |
| | components are contained within an enclosed area within the semi-monocoque. |
| 6. | A device for collecting solar photovoltaic power comprising a semi-monocoque support, |
| | a solar absorber that is directly or indirectly mounted on the support, and electrical components |
| | for conducting and managing electrical energy from the absorber, wherein the electrical |
| | components are contained within an enclosure in the semi-monocoque, wherein |
| | each of the electrical components in the enclosure has two layers of electrical insulation, |
| | and wherein the semi-monocoque comprises a core, said core comprising at least one |
| | support member and at least one perimeter member, and wherein at least one |
| | support member and/or at least one perimeter member comprises a GFRP. |
| 7. | A device for collecting solar photovoltaic power comprising a semi-monocoque support, |
| | and a solar absorber that is directly or indirectly mounted on the support, wherein the |
| | device comprises a 3D-GFRP having voids within the thickness of the 3D-GFRP, and wherein |
| | the voids within the 3D-GFRP facilitate the dissipation of heat produced by the absorber |
| | during operation of the device by means of air convection through the voids of the |
| | 3D-GFRP that permit heated air in the 3D-GFRP to exit. |
| 8. | A device for collecting solar photovoltaic power according to any of embodiments 1 and 3-7, |
| | wherein the support comprises a semi-monocoque. |
| 9. | A device for collecting solar photovoltaic power according to any of embodiments 1-2 and 4-8, |
| | wherein the support comprises an upper layer that comprises a 3D-GFRP. |
| 10. | A device for collecting solar photovoltaic power according to embodiment 9, wherein the |
| | CTE of the 3D-GFRP is less than 8 × 10⁻⁶ C⁻¹. |
| 11. | A device for collecting solar photovoltaic power according to any of embodiments 1-4 and 6-11, |
| | comprising electrical components for conducting and managing electrical energy from the absorber, |
| | wherein the electrical components are contained within an enclosure in the semi-monocoque, and |
| | wherein each of the electrical components in the enclosure has two layers of |
| | electrical insulation. |
| 12. | A device for collecting solar photovoltaic power according to any of embodiments 1-5 and 7-11, |
| | comprising a semi-monocoque support, a solar absorber that is directly or indirectly |
| | mounted on the support, and electrical components for conducting and managing |
| | electrical energy from the absorber, wherein the electrical components are contained |
| | within an enclosure in the semi-monocoque, wherein each of the electrical components |
| | in the enclosure has two layers of electrical insulation, and wherein the semi-monocoque comprises |
| | a core, said core comprising at least one support member and at least one perimeter |
| | member, and wherein at least one support member and/or at least one perimeter member |
| | comprises a GFRP. |
| 13. | A device for collecting solar photovoltaic power according to any of embodiments 1-6 and 8-12, |
| | comprising a semi-monocoque support, and a solar absorber that is directly or indirectly mounted |
| | on the support, wherein the device comprises a 3D-GFRP having voids within the thickness |
| | of the 3D-GFRP, and wherein the voids within the 3D-GFRP facilitate the by the absorber |
| | during operation of the device by means of air convection through dissipation of heat |
| | produced the voids of the 3D-GFRP that permit heated air in the 3D-GFRP to exit. |
| 14. | A device according to any of embodiments 1-13, wherein the device comprises |
| | electrical components that are contained within an enclosure, wherein each of the |
| | electrical components within the enclosure has two layers of electrical insulation, |
| | and wherein the device meets the criteria for a Class II electrical classification. |
| 15. | A device according to any of embodiments 1, 5, 6 and 8-14, wherein the electrical components |
| | that are contained within an enclosure include one or more components selected from |
| | the group consisting of wiring, diodes and overcurrent protectors. |
| 16. | A device according to embodiment 15, wherein the electrical components that are contained |
| | within an enclosure further comprise a micro-inverter. |
| 17. | A device according to embodiment 15 or 16, wherein the electrical components that are |
| | contained within an enclosure further comprise MPPT circuitry. |
| 18. | A device according to embodiment any of embodiments 15-17, wherein the electrical components |
| | that are contained within an enclosure further comprise diagnostic hardware and/or software |
| | that provide a signal when the device is working properly, not working properly, or both. |
| 19. | A device according to any of embodiments 15-18, wherein the enclosure provides an electrically |
| | insulating barrier for the electrical components. |
| 20. | A device according to any of embodiments 15-19, wherein the device further comprises an |
| | ARC-resistant enclosure. |
| 21. | A device according to any of embodiments 15-20, wherein the device has been subject to electrical |
| | performance testing and found to be working properly prior to installation. |
| 22. | A device according to any of embodiments 1-21, wherein the support comprises a GFRP member |
| | that comprises a resin selected from the group consisting of thermoplastic polymers |
| | and thermosetting polymers. |
| 23. | A device according to any of embodiments 1-22, wherein the support comprises a GFRP member |
| | that is substantially fire-resistant. |
| 24. | A device according to any of embodiments 1-23, wherein the support comprises a GFRP member |
| | that comprises a phenolic resin. |
| 25. | A device according to any of embodiments 1-24, wherein the support passes the UL-1703 |
| | structural test criteria. |
| 26. | A device according to embodiments 1-25, wherein the support comprises a 3D-GFRP. |
| 27. | A device according to embodiment 26, wherein the 3D-GFRP comprises a resin selected from |
| | the group consisting of thermoplastic polymers and thermosetting polymers. |
| 28. | A device according to embodiment 26 or 27, wherein the support comprises a 3D-GFRP member |
| | that is substantially fire-resistant. |
| 29. | A device according to any of embodiments 26-28, wherein the support comprises a 3D-GFRP |
| | member that comprises a phenolic resin. |
| 30. | A device according to any of embodiments 13-29, wherein the support comprises a semi-monocoque, |
| | and wherein the semi-monocoque comprises a core, and wherein the core comprises |
| | at least one support member and at least one perimeter member, and wherein |
| | at least one support member and/or at least one perimeter member comprises a GFRP. |
| 31. | A device according to embodiment 30, wherein the at least one support member and/or at least one |
| | perimeter member that is a GFRP comprises a resin selected from the group consisting |
| | of thermoplastic polymers and thermosetting polymers. |
| 32. | A device according to embodiment 30 or 31, wherein the at least one support member |
| | and/or at least one perimeter member that is a GFRP is substantially fire-resistant. |
| 33. | A device according to embodiment 32, wherein the substantially fire resistant GFRP comprises |
| | a phenolic resin. |
| 34. | A device according to any of embodiments 1-33, wherein the support comprises a semi-monocoque |
| | that has a weight per square foot selected from the group consisting of less than |
| | 2.5 lbs/ft2, less than 2.25 lbs/ft2, less than 2.0 lbs/ft2, less than 1.75 lbs/ft2, less than 1.5 lbs/ft2, |
| | less than 1.25 lbs/ft2, less than 1 lb/ft2, and less than 0.75 lb/ft2. |
| 35. | A device according to embodiment 34, wherein the support comprises space for electrical components. |
| 36. | A device according to any of embodiments 1-35, wherein the device has a weight to nameplate power, |
| | when exposed to maximum solar irradiance, of a value selected from the group consisting of: |
| | less than 200 g/per watt of electrical output; less than 200 g/per watt of electrical output; |
| | less than 175 g/per watt of electrical output; less than 150 g/per watt of electrical output; |
| | less than 125 g/per watt of electrical output; less than 100 g/per watt of electrical output, |
| | less than 75 g/per watt of electrical output; less than 50 g/per watt of electrical output; |
| | and less than 40 g/per watt of electrical output. |
| 37. | A device according to any of embodiments 1-36 for collecting solar photovoltaic power comprising |
| | a support and a solar absorber that is directly or indirectly mounted on the support, wherein |
| | the support comprises a semi-monocoque and an upper layer that comprises a 3D-GFRP, |
| | and wherein the 3D-GFRP has a thickness of from 3 mm to 20 mm. |
| 38. | A device for collecting solar photovoltaic power according to embodiment 38, where in wherein |
| | the CTE of the 3D-GFRP is less than 8 × 10⁻⁶ C⁻¹. |
| 39. | A device for collecting solar photovoltaic power according to any of embodiments 1-38, comprising |
| | a semi-monocoque support, and a solar absorber that is directly or indirectly mounted on the support, |
| | wherein the device is substantially rectangular, and wherein the device comprises a 3D-GFRP |
| | having voids within the thickness of the 3D-GFRP, wherein the voids within the |
| | 3D-GFRP facilitate the dissipation of heat produced by the absorber during operation of the |
| | device by means of air convection through the voids of the 3D-GFRP, wherein |
| | the voids permit passage of air within the 3D-GFRP in at least the direction |
| | from a first side of the device to a second side that is opposite the first side of the device, |
| 40. | A device for collecting solar photovoltaic power according to embodiment 39, wherein the device |
| | is adhered to a surface with the second side of the device elevated above the first side, thereby |
| | allowing heated air within the 3D-GFRP to exit from the elevated side of the 3D-GFRP. |
| 41. | A device for collecting solar photovoltaic power according to any of embodiments 1-40, which has |
| | substantially no external metal parts associated with the device. |
| 42. | A device for collecting solar photovoltaic power according to any of embodiments 1-41, which has |
| | no exposed external metal parts associated with the device. |
| 43. | A device for collecting solar photovoltaic power according to any of embodiments 41 and 42, |
| | which only has recessed electrical contacts external to the device. |
| 44. | A device for collecting solar photovoltaic power according to any of embodiments 1-43, wherein |
| | the device does not have wires external to the device. |
| 45. | A device for collecting solar photovoltaic power according to any of embodiments 1-44, which |
| | substantially reduces the need for external grounding of the device. |
| 46. | A device for collecting solar photovoltaic power according to any of embodiments 1-44, which |
| | eliminates the need for external grounding of the device. |
| 47. | A device for collecting solar photovoltaic power according to any of embodiments 1-46 that can pass |
| | one or more tests selected from the group consisting of the “Dielectric withstand test” |
| | or “Hipot test,” the “Protective bonding/continuity test” and/or the “Insulation Resistance Test” |
| | as specified in UL-1703. |
| 48. | A device for collecting solar photovoltaic power according to any of embodiments 1-46 that can |
| | pass two or more tests selected from the group consisting of the “Dielectric withstand test” |
| | or “Hipot test,” the “Protective bonding/continuity test” and/or the “Insulation Resistance Test” |
| | as specified in UL-1703 |
| 49. | A device for collecting solar photovoltaic power according to any of embodiments 1-46 that can pass all three |
| | of the “Dielectric withstand test” or “Hipot test,” the “Protective bonding/continuity test” |
| | and the “Insulation Resistance Test” as specified in UL-1703 |
| 50. | An array comprising two or more devices device according to any of embodiments 1-49, arranged in |
| | electrical communication. |
| 51. | A method for installing an array of solar devices according to any of embodiments 1-49, wherein placing |
| | the devices in connection with one another does not require the connection of wires external to the devices. |

### EXAMPLES

The following non-limiting examples are provided to further illustrate certain identified embodiments described herein and are not intended in any way to limit the scope of the inventions defined in the appended claims.

### Example 1

Using the design described in the FIG. 1a, a prototype version is fabricated wherein the rib and perimeter railing dimensions comprised 2 inch by 9/16 inch by ⅛ inch pultruded GFRP.

The sunlight facing 3D-GFRP solar absorber system comprises a top-most film layer of fluoropolymer film, below which is an EVA layer, below which is a solar cell, below which is another EVA layer, all supported by a semi-monocoque having a 3D-GFRP upper layer.

The prototype consists of a solar PV device which incorporates 72 solar cells bonded to a 39.5 inch by 77.5 inch semi-monocoque structural system. In this example the 3D-GFRP composite is 5 mm thick and adhesively bonded onto the upper surfaces of the semi-monocoque's structural ribs and perimeter railings using an epoxy/polyamidoamine adhesive. Upon completion of this processing, the resulting device is tested for its weight to power output ratio. The weight contribution from the SM and related component was approximately 15.6 pounds and the solar absorber layer contributed approximately 12.2 pounds.

The completed prototype is weighed and the nameplate indicated electrical power output was recorded—recorded—the nameplate power rating of this prototype is 335 watts. Using these data, the grams per watt property is calculated. This prototype's weight:power ratio is determined to be 38 grams per watt.

### Example 2

This example involves a prototype version of the semi-monocoque design that draws upon the design that is described in FIG. 1a to yield a 72 cell solar panel of dimension 77.5 inches length and 39.5 inches width. The prototype's construction is similar to that of Example 1, with following exceptions: the semi-monocoque's core consists of perimeter railings that are 2 5/16 inch high by ¾ inch wide by 3/16 inch thick. In this prototype the configuration of the sunlight facing 3D-GFRP supported solar absorber layers are similar to the arrangement described in Example 1 with the exception that the silicon solar cells are embedded beneath a sunlight facing polycarbonate (Lexan type) protective polymer film. This film is provided in a thickness of approximately 20 mils (500 microns).

The weight of this prototype was measures (30.02 pounds=13.62 kG) and the nameplate power rating (315 watts) results in a weight to electrical power output rating of 43.2 grams per watt.

### Example 3

A prototype version of the 72 cell semi-monocoque design of dimension 77.5 inches by 39.5 inches is constructed and subjected to the mechanical loading test specified in UL-1703. The design of this prototype follows that illustrated in FIG. 1c, with the exception that some of the core's ribs are re-oriented from lateral to longitudinal. More specifically, the two ribs that form the electrical enclosure remain in the lateral orientation, and the remaining ribs are oriented longitudinally (three each at a spacing of approximately 9.9 inches (centerline to centerline dimensions). As shown in FIG. 1c, a longitudinal GFRP tendon is provided as the lower layer.

Testing is carried out in accordance with the UL-1703 standard, wherein the acceptance criteria is a maximum deflection of L/240 when subjected to the full loading as specified therein. This prototype passes the test.

One of ordinary skill in the art will recognize that there could be variations to the embodiments described and illustrated in this disclosure and that those variations would be within the spirit and scope of the inventions described herein. Accordingly, many modifications may be made by one of ordinary skill in the art without departing from the spirit and scope of the appended claims.

1-51. (canceled)

52. An array comprising a plurality of integrated solar photovoltaic (PV) systems for collecting solar photovoltaic power and providing electrical power external to the array of integrated solar PV systems,
wherein each of said integrated solar photovoltaic systems in the plurality comprises an absorber cell network, an electrically insulating enclosure, and electronic components and circuitry,
wherein said electrically insulating enclosure comprises a semi-monocoque comprising top, bottom and perimeter members that form the electrically insulating enclosure,
wherein said electronic components and circuitry are contained within said electrically insulating enclosure and positioned between said top and bottom members of said electrically insulating enclosure, and
wherein the absorber cell network is affixed to the outward facing surface of the top of the electrically insulating enclosure,
wherein the plurality of the integrated solar photovoltaic systems are electrically connected, and
wherein said array is mounted on a building or on the ground.

53. An array comprising a plurality of integrated solar photovoltaic (PV) systems according to claim 52, wherein the array outputs AC power external to the array.

54. An array according to claim 53, wherein each of the integrated solar photovoltaic (PV) systems in the plurality comprises a DC to AC micro-inverter.

55. An array according to claim 52, wherein each of the integrated solar photovoltaic (PV) systems in the plurality comprises glass-fiber reinforced polymer.

56. An array according to claim 52, wherein each of the integrated solar photovoltaic (PV) systems in the plurality provides dual insulation for the electronic components and circuitry in its system.

57. An array according to claim 55, wherein each of the integrated solar photovoltaic (PV) systems in the plurality provides dual insulation for the electronic components and circuitry in its system.

58. An array according to claim 52, wherein there are no exposed external wires that connect the plurality of integrated solar photovoltaic systems.

59. An array according to claim 55, wherein there are no exposed external wires that connect the plurality of integrated solar photovoltaic systems.

60. An array according to claim 57, wherein there are no exposed external wires that connect the plurality of integrated solar photovoltaic systems.

61. An array according to claim 52, wherein the array does not include a grounding circuit external to the solar photovoltaic systems.

62. An array according to claim 55, wherein the array does not include a grounding circuit external to the solar photovoltaic systems.

63. An array according to claim 57, wherein the array does not include a grounding circuit external to the solar photovoltaic systems.

64. An array according to claim 60, wherein the array does not include a grounding circuit external to the solar photovoltaic systems.

65. A method of providing a pre-tested array of integrated solar photovoltaic systems for collecting solar photovoltaic power comprising the steps of:
(a) fabricating a plurality of integrated solar photovoltaic systems for assembly into an array, each system comprising an absorber cell network, an electrically insulating enclosure, and electronic components and circuitry,
wherein said electrically insulating enclosure comprises a semi-monocoque comprising top, bottom and perimeter members that form the electrically insulating enclosure,
wherein said electronic components and circuitry are contained within said electrically insulating enclosure and positioned between said top and bottom members of said electrically insulating enclosure, and
wherein the absorber cell network is affixed to the outward facing surface of the top of the electrically insulating enclosure,
and
(b) testing the fabricated integrated solar photovoltaic systems to determine whether the electronic components, circuitry, or both are properly functioning.

66. A method according to claim 65, wherein the integrated solar photovoltaic system comprises a DC to AC micro-inverter, and the step of testing comprises testing the AC power output of the system.

67. A method according to claim 65, wherein the integrated solar photovoltaic system comprises glass-fiber reinforced polymer.

68. A method according to claim 65, wherein the integrated solar photovoltaic system provides dual insulation for the electronic components and circuitry in its system.

69. A method according to claim 68, wherein the integrated solar photovoltaic system comprises glass-fiber reinforced polymer.

70. A method according to claim 68, wherein the step of testing comprises testing the insulation of the integrated solar photovoltaic system.

71. A method according to claim 70, wherein the integrated solar photovoltaic system comprises glass-fiber reinforced polymer.
